(19) United States
(12) Patent Application Publication
(10) Pub. No.: US 2016/0177021 A1
(43) Pub. Date: Jun. 23, 2016

(54) POLYURETHANE FOAMS AND THE USE THEREOF

(71) Applicant: Covestro Deutschland AG, Leverkusen (DE)

(72) Inventors: Norbert EISEN, Köln (DE); Sebastian SCHLECHT, Hilden (DE); Peter ORYWOL, Lohmar (DE); Günter GANSEN, Neuss (DE)

(73) Assignee: Covestro Deutschland AG, Leverkusen (DE)

(21) Appl. No.: 14/911,053

(22) PCT Filed: Aug. 8, 2014
(86) PCT No.: PCT/EP2014/067099

§ 371 Date: Feb. 9, 2016

(30) Foreign Application Priority Data
Aug. 13, 2013 (EP) 13180161.5

(51) Int. Cl. C08G 18/36; C08G 18/50; C08G 18/48; C08J 9/14; C08G 18/76

(52) U.S. Cl. CPC C08G 18/36; C08J 9/141; C08G 18/7664; C08G 18/4829; C08G 18/5024; C08J 2203/14; C08J 2375/08; C08G 2101/0083

(57) ABSTRACT

The invention relates to polyurethane foams and to the use thereof in foaming of profiles, in particular aluminum profiles, for improving the thermal insulation properties of said profiles.

The present invention relates to polyurethane foams and use thereof in the foam-filling of profiles, in particular aluminum profiles for improving the thermal insulation properties of said profiles.

In the patents EP 1347141 A1 and EP 1760244 A1 it is said that polyurethane foams inter alia are used to improve the thermal insulation provided by aluminum profiles. These foam-filled aluminum profiles are often subsequently coated. This is generally achieved by using a powder coating process at temperatures of, for example, from 180° C. to 210° C. A low U_{F} value is achieved from the aluminum profile by using a polyurethane foam blown by fluorocarbon as physical blowing agent (an example being HFC 365mfc (1,1,1,3,3-pentafluorobutane) or HFC 227ea (1,1,1,2,3,3,3-heptafluoropropane). The U_{F} value here is a variant of the generalized U value and relates to a frame profile (where the index F stands for frame). The U value is defined as heat transfer coefficient. It is a specific characterized value of a component/substance and is mainly used in the construction industry. The general rule is: the higher the heat transfer coefficient U, the poorer the thermal insulation property of the substance. Achievement of a minimal U or U_{F} value therefore contributes to optimization of the thermal insulation provided by the component. The polyurethane foam described above with fluorocarbons as blowing agent has a very fine cell structure with very good insulation properties. This blowing agent has the disadvantage of a substantial adverse effect on global warming (“Global Warming Potential”).

It would alternatively be possible to use a polyurethane foam blown by carbon dioxide, which is produced during the reaction of water with isocyanate. The disadvantage of the adverse effect on global warming could thus be avoided. However, it is known that polyurethane foams blown by CO₂ have markedly poorer thermal conductivity values than foams comprising fluorocarbons or hydrocarbons (e.g. pentane) as blowing agent. This means that in order to achieve the same U_{F} value for an aluminum profile a CO₂-blown polyurethane foam has to be markedly thicker than polyurethane foam blown, for example, with pentane. Since by way of example aluminum profiles for windows are subject to a depth restriction, a CO₂-blown polyurethane foam always leads to a poorer U_{F} value.

Because hydrocarbons (e.g. hexane, pentane, butane) have low global warming potential and excellent thermal conductivity properties (very good insulation properties), use of hydrocarbon-blown polyurethane foams would be the ideal solution for the foam-filling of aluminum profiles. Unfortunately, it has been found in practice that when polyurethane foams of this type undergo the coating process at temperatures above 180° C. they are either destroyed completely, or break up, or expand to such a degree that they cause the aluminum profiles to separate. Polyurethane foams known hitherto that are blown by hydrocarbons cannot therefore be used in the powder coating process (temperatures >180° C.).

It was therefore an object to provide a polyurethane foam which is blown by CO₂ or by CO₂/hydrocarbon (in particular pentane) and which has an envelope density of from 60 to 150 g/dm³, and which can be used for the foam-filling of, for example, aluminum profiles, which is heat-resistant at temperatures of from 180° C. to 210° C., and which can be used for up to 40 minutes in the powder coating process at from 180° C. to 210° C. without destruction, break-up, or excessive expansion of the foam.

Said object has been achieved via the polyurethane foams which are described in more detail below, comprising a high proportion of castor oil and blown by CO₂ or CO₂/hydrocarbon.

The present invention provides polyurethane foams of density from 60 g/dm³ to 150 g/dm³ in accordance with DIN EN 845 and with Shore A hardness >70 in accordance with DIN 53505 and with heat resistance of up to 40 minutes at from 180° C. to 210° C., characterized in that they are obtainable from the reaction of components composed of
a) an isocyanate component composed of
   i) room-temperature-liquid di- and/or polyisocyanates of the diphenylmethane group with from 28% by weight to 33.6% by weight NCO content
b) a polyol component composed of
   i) from ≧60 to 80% by weight, preferably from ≧65 to 80% by weight, based on the polyol component, of castor oil and/or derivatives of castor oil
   ii) diamine and/or polyamine-started alkylene oxides with molar masses from 170 to 4800 g/mol, preferably from 200 to 2000 g/mol, and functionalities from 3 to 8, preferably from 4 to 6
   iii) optionally one or more crosslinking agents from the group consisting of alcohols and polyether polyols respectively with molar masses (in g/mol) from 92 to 3500, preferably from 300 to 2000, and functionalities from 2 to 8, preferably from 3 to 6
   iv) water
   v) optionally hydrocarbons as physical blowing agents, in particular pentane
   vi) catalysts
   vii) foam stabilizers
   viii) optionally auxiliaries and/or additives,
   where the quantity used of component a) and b) is such that the index is from 90 to 150, preferably from 100 to 140, particularly preferably from 120 to 130.

The quantity used of the castor oil b)i) is preferably from ≧65 to 80% by weight, particularly preferably from ≧70 to 80% by weight, based on the polyol component b).

The quantity of the components b)ii) is preferably from 10 to 25% by weight, based on the polyol component b).

The quantity used of the crosslinking agent b)iii), to the extent that these are present, is preferably from 10 to 20% by weight, based on the polyol component b).

The quantities used of the blowing agents b)iv) and b)v) together are preferably from 1 to 10% by weight, based on the polyol component b).

In quantities used of the catalyst b)vi) are preferably from 0.1 to 3.0% by weight, based on the polyol component b).

The quantity of foam stabilizers b)vii) is preferably in the range from 1 to 3% by weight, based on the polyol component b).

The quantities present of the auxiliaries and/or additives b)viii) are preferably from 0.5 to 5% by weight, based on the polyol component b).

The polyurethane foams of the invention have good insulation properties and are suitable for the foam-filling of aluminum profiles. They are heat-resistant (up to 40 minutes at from 180° C. to 210° C.), and they can therefore used in the powder coating of profiles.

The polyurethane foams of the invention are therefore preferably used in the foam-filling of profiles, in particular aluminum profiles, in order to improve the thermal insulation properties of said profiles.

It has surprisingly been found that polyurethane foams which comprise a high proportion of castor oil had particularly good heat resistance properties. The particularly preferred pentane-blown polyurethane foams exhibit extremely high heat resistance and therefore suitability in the powder coating process. Particular preference is given to cyclopentane.

The polyurethane foams of the invention are in particular suitable for the foam-filling of window profiles, door profiles, and facade profiles, in particular for profiles which are then subjected to a powder coating process.

Isocyanate component a) used comprises room-temperature-“liquid” di- and/or polyisocyanates from the diphenylmethane group. Among these are inter alia room-temperature-liquid and optionally correspondingly modified mixtures of 4,4′-diisocyanatodiphenylmethane with 2,4′- and optionally 2,2′-diisocyanatodiphenylmethane. Other materials with good suitability are room-temperature-liquid polyisocyanate mixtures from the diphenylmethane group which comprise not only the isomers mentioned but also higher homologs thereof, and which are obtainable in a manner known per se via phosgenation of aniline/formaldehyde condensates. Other suitable materials are modification products of these di- and/or polyisocyanates, where said products have urethane groups and/or carbodiimide groups. Other suitable materials are modification products of the di- and/or polyisocyanates mentioned, where said products have allophanate groups or biuret groups. The average NCO functionality of isocyanate component a) is from 2.1 to 5.0, preferably from 2.5 to 3.1.

Castor oil is the term used for a natural vegetable oil which is obtained from the seeds of the tropical castor oil plant. It is a triglyceride derived from glycerol and various fatty acids, mainly ricinoleic acid. The term derivatives here means the substances known from the prior art that are obtainable via modification of the oils. Examples of modifications are changes at the double bonds, for example via polymerization resulting from heat, isomerization, dehydration, or addition or substitution at the double bonds, or changes to the glycerides system, e.g. via transesterification.

Crosslinking agents b)iii) used can in particular comprise alcohols (e.g. glycerol) and/or polyether polyols. These are preferably polyhydroxy polyethers, where these can be produced in a known manner via a polyaddition reaction of alkylene oxides onto polyfunctional starter compounds in the presence of catalysts. The poly(oxyalkylene) polyols used in the invention are preferably produced from a starter compound having an average of from 2 to 8 active hydrogen atoms and one or more alkylene oxides. Particularly preferred starter compounds are molecules having from three to six hydroxy groups per molecule. Examples are triethanolamine, glycerol, trimethylolpropane, pentaerythritol, sorbitol, and sucrose. The starter compounds can be used alone or in a mixture, inter alia with difunctional starter compounds such as diethylene glycol, dipropylene glycol, triethylene glycol, tripropylene glycol, 1,4-butanediol, 1,6-hexanediol. The polyether polyols used in the invention are produced from one or more alkylene oxides. Alkylene oxides preferably used are oxirane, methyloxirane, and ethyloxirane. These can be used alone or in a mixture. In the event of use in a mixture it is possible to react the alkylene oxides randomly or in blocks, or to react the two in succession.

Crosslinking agents b)ii) used moreover comprise diamine- and/or polyamine-started polyethers. These are adducts derived from alkylene oxides with aliphatic or aromatic di- or polyamines having primary and/or secondary amino groups. Examples of starter molecules of this type are tolylenediamine, isophoronediamine, and ethylenediamine.

Blowing agents used comprise water and optionally hydrocarbons, for example cyclopentane, isopentane, n-pentane, hexane, butane, or mixtures of these. It is preferable to use cyclopentane, isopentane, and n-pentane, individually or as mixture.

The quantity used of the catalysts that are per se conventional in polyurethane chemistry, e.g. tertiary amine or metal salts, is from 0.1 to 3% by weight in the invention, based on the entirety of polyol component b).

Alongside the foam stabilizers b)vii), a quantity of from 1 to 3%, based on polyol component b), of other auxiliaries and/or additives b)viii) can also be used.

Other auxiliaries and/or additives b)viii) that can optionally be used comprise paraffins, fatty alcohols, pigments and/or dyes, flame-retardant substances, and also stabilizers to counter the effects of aging and of weathering, plasticizers, and fungistatic and bacteriostatic substances, and also fillers such as barium sulfate, kieselguhr, carbon black, whiting, cell regulators, reaction retarders, and other stabilizers, e.g. polysiloxanes. Details concerning the manner of use and action of these auxiliaries and additives are described in Kunststoff-Handbuch [Plastics handbook], volume VII, edited by Vieweg and Höchtlen, Carl Hanser Verlag Munich, 1966, for example on pp. 121 to 205.

Quantities of isocyanate component a) and polyol component b) reacted for the production of the polyurethanes are such that the ratio of the number of the NCO groups of isocyanate component a) to the number of the reactive hydrogen atoms in polyol component b) is from 1:0.9 to 1:1.5 (corresponding to an index (ratio multiplied by 100) of from 90 to 150), preferably from 1:1 to 1:1.4, and particularly preferably from 1:1.2 to 1:1.3.

The temperature at which the starting components are usually mixed and reacted is from 15 to 60° C. The mixing can be achieved by using conventional polyurethane-processing machines. In one preferred embodiment the mixing is achieved by using low-pressure machines or high-pressure machines. The foaming during foam production can be achieved in an open mold and by an open charging method. However, it can also be achieved in a closed mold. Here, the reaction mixture is introduced into a mold, for example made of aluminum or plastic. The foamable reaction mixture foams in the mold and forms the molding. It is, of course, also possible to produce polyurethane foams via block foaming or by the twin-belt process known per se.

The examples below will provide further explanation of the invention.

### EXAMPLES

The polyurethane foams were produced on a laboratory scale by using as initial charge, in a mixing beaker made of paperboard, isocyanate component a) together with polyol component b) and optionally the physical blowing agent. A laboratory stirrer was used to mix the components at 2000 revolutions per minute (rpm). The mixture was then charged to an open mold of basal area 20×1 cm² for the foaming process. The foaming process gave a fine-cell polyurethane foam.

Table 1 reveals the precise compositions and properties measured. The input weight of the components is in parts by weight (pts.).

The heat resistance of the polyurethane foams of the invention was determined by sealing U-profiles made of polyamide or aluminum (dimensions (width×length×height): 20 mm×300 mm×48 mm) at their ends, charging the foam produced by an open charging method to said profiles, and exposing the system to a defined temperature in an oven. Preference was given to U-profiles made of polyamide because these undergo no alteration at the temperatures of the powder coating procedure. These U-profiles made of polyamide were filled with a polyurethane foam in order to improve thermal insulation. The detail of the procedure is as follows: 33 g of the polyurethane mixture (optionally with physical blowing agent) were charged to the corresponding U-profile made of polyamide. This mixture then foamed freely in such a way that the upper portion of the foam body protruded vertically upward beyond the lateral limits of the U-profile (the height of the foam body being about 80 mm). It was important here that the foam body did not incline, or fall, beyond the lateral limit. After at least 24 hours the surface hardness (Shore A hardness) of the resultant foam bodies was determined in accordance with DIN 53505, and the envelope density thereof was determined in accordance with the immersion method, DIN ISO 1183-A-2004 (test sample 30 mm×30 mm×20 mm). The foam-filled U-profiles were then placed centrally in an oven (Heraeus T 5042K, convection, 200° C., dimensions (W×H×D): 420 mm×350 mm×320 mm) for 20 minutes. The heat altered the color of the polyurethane foams, without any effect on either mechanical properties or thermal insulation properties. Decisive factors for heat resistance were that the heat did not cause complete destruction of the polyurethane foam, did not cause break-up thereof (where break-up means cracks >2 cm.), and did not cause loss of stability (where stability means change of surface hardness <10%) or extreme expansion or shrinkage (where expansion or shrinkage means change of density >10%).

These aspects are important for permitting use of a polyurethane foam for providing insulation to aluminum profiles, for example for the production of window profiles. If the heat causes destruction of, or severe shrinkage of, a polyurethane foam, thermal insulation properties are impaired and the polyurethane foam can no longer be used as insulation foam. If, in contrast, the heat causes a high degree of expansion of a polyurethane foam, the foam can force the polyamide U-profile or the aluminum profile apart, with resultant loss of dimensional accuracy.

Table 1 shows the alteration of the polyurethane foams caused by heat at 200° C. for 20 minutes.

TABLE 1
Compositions and properties of the polyurethanes produced

| | 1 | 2 | 3 | 4 |
|---|---|---|---|---|
| | (of the | (not of the | (of the | (not of the |
| | invention) | invention) | invention) | invention) |
| Polyol | 76.5 pts. of | 40 pts. of castor | 70 pts. of castor | 40 pts. of castor |
| component | castor oil | oil | oil | oil |
| | 17 pts. of | 53.5 pts. of | 12 pts. of | 27 pts. of |
| | polyol B | polyol B | polyol A | polyol A |
| | 2 pts. of water | 2 pts. of water | 12 pts. of | 27 pts. of |
| | 2 pts. of | 2 pts. of | polyol B | polyol B |
| | Tegostab | Tegostab | 1 pts. of water | 1 pts. of water |
| | B8411 | B8411 | 2.5 pts. of | 2.5 pts. of |
| | 2.5 pts. of | 2.5 pts. of | Tegostab | Tegostab |
| | Dabco 33LV | Dabco 33LV | B8411 | B8411 |
| | | | 2.5 pts. of | 2.5 pts. of |
| | | | Dabco 33LV | Dabco 33LV |
| Physical blowing | — | — | 5 pts. of | 7 pts. of |
| agent | | | cyclopentane | cyclopentane |
| Isocyanate | Desmodur ® | Desmodur ® | Desmodur ® | Desmodur ® |
| component | 44V20 | 44V20 | 44V20 | 44V20 |
| Isocyanate index | 130 | 130 | 120 | 130 |
| Density of | 61 g/L | 84 g/L | 60 g/L | 62 g/L |
| polyurethane | | | | |
| foam | | | | |
| Shore A hardness | 72/75 | 50/25 | 70/65 | 48/30 |
| of surface (before/ | | | | |
| after heating at | | | | |
| 200° C. for 20 min.) | | | | |
| Change of Shore | 4% | 50% | 7% | 38% |
| A hardness of | | | | |
| surface (due to | | | | |
| heating at 200° C. | | | | |
| for 20 min.) | | | | |
| Expansion due to | No expansion | High degree of | No expansion | High degree of |
| heating at 200° C. | (slight | expansion | (slight | expansion |
| for 20 min. | shrinkage) | | shrinkage) | |
| Density | 7% | 31% | 7% | 26% |
| difference due to | | | | |
| heating at 200° C. | | | | |
| for 20 min. | | | | |
| Cracking in | no | yes | no | yes |
| polyurethane | | | | |
| foam (cracks | | | | |
| >2 cm) due to | | | | |
| heating at 200° C. | | | | |
| for 20 min. | | | | |
| Heat resistance at | yes | no | yes | no |
| 200° C. for 20 min. | | | | |

Castor Oil:

Technical quality, hydroxy number about 160 mg KOH/g, supplier: Alberdink Boley, Krefeld.

Polyol A:

Sorbitol-, water-, glycerol-started polyether with molar mass 575 g/mol, obtained via an anionic polyaddition reaction onto propylene oxide.

Polyol B:

Ethylenediamine-started polyether with molar mass 275 g/mol, obtained via an anionic polyaddition reaction onto propylene oxide.

Tegostab B8411: Polyurethane foam stabilizer (polyether polysiloxane), producer: Goldschmidt AG, Essen.

Dabco 33LV:

Tertiary amine catalyst (1,4-diazabicyclo[2.2.2]octane) in solution, producer: Sigma-Aldrich.

Demodur® 44V20:

Isocyanate based on the diphenylmethane group, producer: Bayer MaterialScience AG, Leverkusen.

As can be seen from examples 1 to 4, the heat resistance required at 200° C. for 20 minutes can be achieved only if there is a high proportion of castor oil (≧60% by weight, particularly preferably ≧65% by weight, based on polyol component b)) in the polyol component. Not only the purely water-blown polyurethane foam (example 1) but also the water/cyclopentane-blown polyurethane foam (example 3) complies with the heat resistance desired. After heating at 200° C. for 20 minutes in examples 2 and 4 there was a marked decrease in Shore A hardness, the polyurethane foam expanded to a high degree, and there was also a high degree of cracking in the polyurethane foam. These polyurethane foams cannot therefore be used as insulation foams in the frames that are subjected to this type of heat treatment.

1.-2. (canceled)

3. A polyurethane foam having a density from 60 g/dm³ to 150 g/dm³ in accordance with DIN EN 845 and a Shore A hardness >70 in accordance with DIN 53505 and with heat resistance of up to 40 minutes at from 180° C. to 210° C., wherein the foam is obtained from the reaction of components
a) an isocyanate component composed of
i) room-temperature-liquid di- and/or polyisocyanates of the diphenylmethane group with from 28% by weight to 33.6% by weight NCO content
b) a polyol component composed of
i) from ≧60 to 80% by weight, based on the polyol component, of castor oil and/or derivatives of castor oil
ii) diamine and/or polyamine-started alkylene oxides with molar masses from 170 to 4800 g/mol, and functionalities from 3 to 8
iii) optionally one or more crosslinking agents from the group consisting of alcohols and polyether polyols with molar masses from 92 to 3500 g/mol, and functionalities from 2 to 8,
iv) water
v) optionally hydrocarbons as physical blowing agents
vi) catalysts
vii) foam stabilizers
viii) optionally auxiliaries and/or additives,
wherein the quantity of component a) and b) is such that the index is from 90 to 150.

4. An article comprising the polyurethane foam as claimed in claim 3 wherein the article is selected from the group consisting of a window profiles, a door profile, and a facade profile.

5. The article of claim 4, wherein the profile is powder coated.

6. A method comprising incorporating the polyurethane foam as claimed in claim 3 as a foam-filling in an article selected from the group consisting of a window profiles, a door profile, and a facade profile.

7. A foam-filling comprising the polyurethane foam as claimed in claim 3.

8. The polyurethane foam of claim 3, wherein the amounts are as follows: component b)i) is from ≧65 to 80% by weight, based on the polyol component, b)ii) is from 10 to 25% by weight, based on the polyol component b), the crosslinking agent b)iii), is from 10 to 20% by weight, based on the polyol component b), catalyst b)vi) is from 0.1 to 3.0% by weight, based on the polyol component b), the auxiliaries and/or additives b)viii) are from 0.5 to 5% by weight, based on the polyol component b).
